(19) United States
(12) Patent Application Publication
(10) Pub. No.: US 2026/0043216 A1
(43) Pub. Date: Feb. 12, 2026

(54) METHOD FOR CALIBRATING COORDINATES OF A BUCKET, METHOD FOR UPDATING COORDINATE CALIBRATION, COMPUTER DEVICE, CALIBRATION SYSTEM, NON-TRANSITORY COMPUTER-READABLE STORAGE MEDIUM AND EXCAVATOR

(71) Applicants: JIANGSU XCMG CONSTRUCTION MACHINERY RESEARCH INSTITUTE LTD., XUZHOU, JIANGSU (CN); JIANGSU XCMG STATE KEY LABORATORY TECHNOLOGY CO., LTD., XUZHOU, JIANGSU (CN)

(72) Inventors: Houxue MA, XUZHOU, JIANGSU (CN); Jian ZHANG, XUZHOU, JIANGSU (CN); Yu ZHAO, XUZHOU, JIANGSU (CN); Hongjun PU, XUZHOU, JIANGSU (CN)

(73) Assignees: JIANGSU XCMG CONSTRUCTION MACHINERY RESEARCH INSTITUTE LTD., XUZHOU, JIANGSU (CN); JIANGSU XCMG STATE KEY LABORATORY TECHNOLOGY CO., LTD., XUZHOU, JIANGSU (CN)

(21) Appl. No.: 18/995,818

(22) PCT Filed: Dec. 30, 2022
(86) PCT No.: PCT/CN2022/143871

§ 371 Date: Jan. 16, 2025

(30) Foreign Application Priority Data
Dec. 26, 2022 (CN) 202211674601.1

(51) Int. Cl. E02F 9/26; G01S 7/48; G01S 7/497; G01S 17/88

(52) U.S. Cl. CPC E02F 9/264; G01S 7/4808; G01S 7/497; G01S 17/88

(57) ABSTRACT

A method for calibrating coordinates of a bucket, a method for updating coordinate calibration, a computer device, a calibration system, a non-transitory computer-readable storage medium and an excavator are provided. The method for calibrating coordinates of a bucket includes: acquiring lidar point cloud data and angle sensor data of the bucket of an excavator; determining coordinates of a middle bucket tooth of the bucket in a lidar coordinate system according to the lidar point cloud data of the bucket; determining the coordinates of the middle bucket tooth of the bucket in an excavator coordinate system according to the angle sensor data of the bucket; and determining a coordinate calibration matrix according to the coordinates of the middle bucket tooth of the bucket in the lidar coordinate system and in the excavator coordinate system.

### CROSS-REFERENCE TO RELATED APPLICATIONS

The present application is based on and claims priority to China Patent Application No. 202211674601.1 filed on Dec. 26, 2022, the disclosure of which is incorporated by reference herein in its entirety.

### TECHNICAL FIELD

The present disclosure relates to the intelligent field of construction machinery, in particular to a method and a device for calibrating coordinates of a bucket, an updating method and apparatus, and an excavator.

### BACKGROUND

As far as the operation conditions of the excavator for excavating the bulk materials in the related art are concerned, it is desirable to detect a size of a material pile and a position of the target excavation point may be detected by a sensing device, and the excavator may be informed of a target position, so as to realize the unmanned automatic excavation operation of the excavator.

### SUMMARY

According to one aspect of the present disclosure, a method for calibrating coordinates of a bucket is provided. The method comprises: acquiring lidar point cloud data and angle sensor data of the bucket of an excavator; determining coordinates of a middle bucket tooth of the bucket in a lidar coordinate system according to the lidar point cloud data of the bucket; determining the coordinates of the middle bucket tooth of the bucket in an excavator coordinate system according to the angle sensor data of the bucket; and determining a coordinate calibration matrix according to the coordinates of the middle bucket tooth of the bucket in the lidar coordinate system and in the excavator coordinate system, wherein the coordinate calibration matrix is a calibration matrix for calibrating the coordinates of the middle bucket tooth of the bucket in the lidar coordinate system to the excavator coordinate system.

In some embodiments of the present disclosure, the acquiring the lidar point cloud data and the angle sensor data of the bucket of the excavator comprises: acquiring the lidar point cloud data and the angle sensor data of the bucket in a plurality of different positions.

In some embodiments of the present disclosure, the determining the coordinates of the middle bucket tooth of the bucket in the lidar coordinate system according to the lidar point cloud data of the bucket comprises: determining the coordinates of the middle bucket tooth of the bucket in the lidar coordinate system according to the lidar point cloud data of the bucket acquired at each of the different positions.

In some embodiments of the present disclosure, the determining the coordinates of the middle bucket tooth of the bucket in the excavator coordinate system according to the angle sensor data of the bucket comprises determining the coordinates of the middle bucket tooth of the bucket in the excavator coordinate system according to the angle sensor data of the bucket acquired at the each of the different positions.

In some embodiments of the present disclosure, the determining the coordinates of the middle bucket tooth of the bucket in the lidar coordinate system according to the lidar point cloud data of the bucket acquired at the each of the different positions comprises: determining the coordinates of the middle bucket tooth of the bucket in the lidar coordinate system by using an implicit shape model algorithm according to the lidar point cloud data of the bucket acquired at the each of the different positions.

In some embodiments of the present disclosure, the determining the coordinates of the middle bucket tooth of the bucket in the excavator coordinate system according to the angle sensor data of the bucket acquired at the each of the different positions comprises: calculating a forward kinematics solution of the excavator, to determine the coordinates of the middle bucket tooth of the bucket in the excavator coordinate system according to the angle sensor data of the bucket acquired at the each of the different positions.

In some embodiments of the present disclosure, the determining the coordinate calibration matrix according to the coordinates of the middle bucket tooth of the bucket in the lidar coordinate system and in the excavator coordinate system comprises: constructing a plurality of data pairs of the coordinates of the lidar coordinate system and the coordinates of the excavator coordinate system according to the coordinates of the middle bucket tooth of the bucket in the lidar coordinate system and in the excavator coordinate system, and dividing the plurality of data pairs into training set data and testing set data; determining the coordinate calibration matrix according to the training set data; and verifying the coordinate calibration matrix by using the test set data.

In some embodiments of the present disclosure, the coordinate calibration matrix is a coordinate rotation and translation transformation matrix.

In some embodiments of the present disclosure, the determining the coordinate calibration matrix according to the training set data comprises: initializing related parameters, wherein the related parameters comprise iteration times; selecting a predetermined number of first data pairs randomly; determining whether the first data pairs are collinear; and determining the coordinate calibration matrix by a direct linear transformation in a case where the first data pairs are not collinear.

In some embodiments of the present disclosure, the determining the coordinate calibration matrix according to the training set data, further comprises: transforming the coordinates of the lidar coordinate system in second data pairs to acquire the coordinates of the excavator coordinate system by using the coordinate calibration matrix, wherein the second data pairs are data pairs other than the first data pairs in the training set data; calculating a distance deviation between the transformed coordinates of the excavator coordinate system and the actual coordinates of excavator coordinate system; determining whether the distance deviation is smaller than a predetermined distance threshold; recording interior points conforming to conditions and updating the coordinate calibration matrix according to the iteration times and the determining result of the distance deviation; and calculating an interior point probability and updating the iteration times according to the interior point probability.

According to another aspect of the present disclosure, a method for updating coordinate calibration is provided. The method comprises: determining whether an online error of a coordinate calibration matrix is greater than a predetermined allowable error; determining whether a number of data pairs of acquired position points reaches a predetermined position point number in a case where the online error of the coordinate calibration matrix is greater than the predetermined allowable error; determining a new coordinate calibration matrix by using the method according to any of the above-described embodiments in a case where the number of the data pairs of the acquired position points is equal to the predetermined position point number; and updating the coordinate calibration matrix.

In some embodiments of the present disclosure, the method further comprises: acquiring the lidar point cloud data of the bucket and determining one coordinate of the middle bucket tooth of the bucket in the lidar coordinate system in a case where the number of the data pairs of the acquired position points is less than the predetermined position point number; acquiring the angle sensor data of the bucket and determining one coordinate of the middle bucket tooth of the bucket in the excavator coordinate system; and accumulating the number of the data pairs of the position points, and then performing the determining whether the number of the data pairs of the acquired position points reaches the predetermined position point number again.

In some embodiments of disclosure, the determining one coordinate of the middle bucket tooth of the bucket in the lidar coordinate system comprises: acquiring one coordinate of the middle bucket tooth of the bucket in the lidar coordinate system by using an implicit shape model algorithm; determining whether a model similarity is greater than a predetermined similarity; and using the acquired one coordinate of the middle bucket tooth of the bucket in the lidar coordinate system in a case where the model similarity is greater than the preset similarity.

In some embodiments of the present disclosure, the determining one coordinate of the middle bucket tooth of the bucket in the excavator coordinate system comprises: calculating a forward kinematics solution of the excavator based on the angle sensor data and determining the one coordinate of the middle bucket tooth of the bucket in the excavator coordinate system.

According to another aspect of the present disclosure, a device for calibrating coordinates of a bucket is provided. The device comprises: a data acquiring module configured to acquire lidar point cloud data and angle sensor data of the bucket of an excavator; a positioning module configured to determine coordinates of a middle bucket tooth of the bucket in a lidar coordinate system according to the lidar point cloud data of the bucket; and determine the coordinates of the middle bucket tooth of the bucket in an excavator coordinate system according to the angle sensor data of the bucket; and a calibration module configured to determine a coordinate calibration matrix according to the coordinates of the middle bucket tooth of the bucket in the lidar coordinate system and in the excavator coordinate system, wherein the coordinate calibration matrix is a calibration matrix for calibrating the coordinates of the middle bucket tooth of the bucket in the lidar coordinate system to the excavator coordinate system.

In some embodiments of the present disclosure, the device for calibrating the coordinates of the bucket is configured to perform the method according to any of the above-described embodiments.

According to another aspect of the present disclosure, an apparatus for updating coordinate calibration is provided. The apparatus comprises: a determination device configured to determine whether an online error of a coordinate calibration matrix is a predetermined allowable error; and determine whether a number of data pairs of acquired position points reaches a predetermined position point number in a case where the online error of the coordinate calibration matrix is greater than the predetermined allowable error; a device for calibrating coordinates of a bucket, configured to determine a new coordinate calibration matrix by using a method for calibrating coordinates of a bucket in a case where the number of the data pairs of the acquired position points is equal to the number of predetermined position point number; and an updating device configured to update the coordinate calibration matrix.

In some embodiments of the present disclosure, the device for calibrating the coordinates of the bucket is the device for calibrating the coordinates of the bucket according to any of the above-described embodiments.

In some embodiments of the present disclosure, the apparatus is configured to perform the method for updating the coordinate calibration according to any of the above-described embodiments.

According to another aspect of the present disclosure, a computer device is provided. The device comprises: a memory for storing instructions; a processor configured to execute the instructions, so that the computer device performs the method according to any of the above-described embodiments.

According to another aspect of the present disclosure, a calibration system is provided. The system comprises a lidar, an angle sensor, and further comprising at least one of a computer device, an apparatus for updating coordinate calibration and a device for calibrating coordinates of a bucket, wherein the computer device is the computer device according to any of the above-described embodiments, the apparatus for updating coordinate calibration is the apparatus for updating the coordinate calibration according to any of the above-described embodiments, and the device for calibrating the coordinates of the bucket is the device for calibrating the coordinates of the bucket according to any of the above-described embodiments.

According to another aspect of the present disclosure, an excavator is provided. The excavator comprises a lidar, and further comprising at least one of a computer device, an apparatus for updating coordinate calibration and a device for calibrating coordinates of a bucket, wherein the computer device is the computer device according to any of the above-described embodiments, the apparatus for updating coordinate calibration is the apparatus for updating the coordinate calibration according to any of the above-described embodiments, and the device for calibrating the coordinates of the bucket is the device for calibrating the coordinates of the bucket according to any of the above-described embodiments.

According to another aspect of the present disclosure, a computer-readable storage medium is provided, wherein the computer-readable storage medium has computer instructions stored thereon that when executed by a processor, perform the method for updating the coordinate calibration according to any of the above-described embodiments.

### BRIEF DESCRIPTION OF THE ACCOMPANYING DRAWINGS

In order to more explicitly explain the embodiments of the present disclosure or the technical solutions in the relevant art, a brief introduction will be given below for the accompanying drawings required to be used in the description of the embodiments or the relevant art. It is obvious that, the accompanying drawings described as follows are merely some of the embodiments of the present disclosure. For those skilled in the art, other accompanying drawings may also be acquired according to such accompanying drawings on the premise that no inventive effort is involved.

FIG. 1 is a schematic view of the operation conditions of excavating the bulk materials by the excavator according to some embodiments of the present disclosure.

FIG. 2 is a schematic view of the method for calibrating the coordinates of the bucket according to some embodiments of the present disclosure.

FIG. 3 is a schematic view of the method for calibrating the coordinates of the bucket according to other embodiments of the present disclosure.

FIG. 4 is a schematic view of the method for updating the coordinate calibration according to some embodiments of the present disclosure.

FIG. 5 is a schematic view of the method for updating the coordinate calibration according to other embodiments of the present disclosure.

FIG. 6 is a schematic view of the device for calibrating the coordinates of the bucket according to some embodiments of the present disclosure.

FIG. 7 is a schematic view of the apparatus for updating the coordinate calibration according to some embodiments of the present disclosure.

FIG. 8 is a structural view of the computer device according to some embodiments of the present disclosure.

### DETAILED DESCRIPTION

The technical solution in the embodiments of the present disclosure will be explicitly and completely described below in conjunction with the accompanying drawings in the embodiments of the present disclosure. Apparently, the embodiments described are merely some of the embodiments of the present disclosure, rather than all of the embodiments. The following descriptions of at least one exemplary embodiment which are in fact merely illustrative, shall by no means serve as any delimitation on the present disclosure as well as its application or use. On the basis of the embodiments of the present disclosure, all the other embodiments acquired by those skilled in the art on the premise that no inventive effort is involved shall fall into the protection scope of the present disclosure.

Unless otherwise specified, the relative arrangements, numerical expressions and numerical values of the components and steps expounded in these examples shall not limit the scope of the present invention.

At the same time, it should be understood that, for ease of description, the dimensions of various parts shown in the accompanying drawings are not drawn according to actual proportional relations.

The techniques, methods, and apparatuses known to those of ordinary skill in the relevant art might not be discussed in detail. However, the techniques, methods, and apparatuses shall be considered as a part of the granted description where appropriate.

Among all the examples shown and discussed here, any specific value shall be construed as being merely exemplary, rather than as being restrictive. Thus, other examples in the exemplary embodiments may have different values.

It is to be noted that: similar reference signs and letters present similar items in the following accompanying drawings, and therefore, once an item is defined in one accompanying drawing, it is necessary to make further discussion on the same in the subsequent accompanying drawings.

The inventors have found through studies that: the size of the material pile and the position of the target excavation point are detected by a lidar at the excavation site of excavating the bulk materials by the excavator, wherein the lidar is mounted outside the excavator. The position of the bucket is detected by an angle sensor, wherein the angle sensor is mounted on the excavator. The function of automatic excavation operation for the target excavation point is realized by planning and controlling a bucket trajectory. In this scenario, in order to achieve accurate excavation, the target excavation point has to be accurately measured, and the accurate measurement is on premise of coordinate calibration, that is, the coordinates of the bucket and the target excavation point in the lidar coordinate system are accurately calibrated in the excavator coordinate system, so as to realize that the coordinates of the bucket and the coordinates of the target excavation point are uniform in the excavator coordinate system.

The common methods for calibrating the coordinates in the related art: a direct measurement method, a manual point selection method and a scenario characterization method. These methods in the related art are also present with the following deficiencies: the calibration accuracy is low in the direct measurement method, and the direct measurement method and the manual point selection method are prone to have various errors, including those caused by artificial operation.

The inventors have also found through studies that: the direct measurement method, the manual point selection method and the scenario characterization method are also present with the following deficiencies:
1) The manual point selection method is time-consuming and labor-intensive. Artificial intervention is required in both the direct measurement method and the manual point selection method. If a large number of devices are calibrated, it is possible to bring about a lot of workload, which makes it difficult to realize mass production of the intelligent system in both the direct measurement method and the manual point selection method.
2) In the scenario characterization method, it is necessary to design a specific scenario for calibration of the sensors, so that it is impossible to realize on-line calibration of the sensors.
3) In the above-described methods, the function of online verification of the calibration errors during operation is absent, and calibration cannot be updated online especially when the relative position of the excavator and the lidar changes.

The related art relates to a sensor positioning system, which is capable of calculating the positions of the sensors of at least one or more self-driving vehicle based on surface data, However, firstly, it is necessary to perform multiple measurement transformations; secondly, the functions of error verification and online updating are absent.

The related art also discloses a method for calibrating a sensor device mounted on a machine, which is capable of realizing the calibration of the devices mounted on the machine. However, firstly, it is necessary to acquire topographic point clouds with multiple features and perform registration twice so as to realize the calibration of the sensor device mounted on the machine; secondly, it is impossible to perform online calibration when the relative positions of the sensors change.

In another related art, off-line calibration can be realized. However, firstly, a specific joint calibration target including a chessboard calibration board and an L-shape is required; secondly, online calibration cannot be performed.

In another related art, off-line calibration can be realized. However, firstly, a specific calibration board is required. Secondly, in order to acquire the first coordinate value of each feature point on the calibration board in a lower vehicle body coordinate system of the operation machine, it is necessary to perform manual measurement by a measuring tool such as a tape, or control the operation machine to perform automatic measurement. However, manual measurement is troublesome and accurate measurement is difficult while how to perform automatic measurement is not explained. Thirdly, online calibration cannot be performed.

In view of at least one of the above technical problems, the present disclosure provides a method and a device for calibrating coordinates of a bucket, an updating method and apparatus, and an excavator, which may calibrate the coordinates of the bucket by using the lidar and the excavator angle sensor without adding an external calibration device. Next, the present disclosure will be explained by the embodiments.

FIG. 1 is a schematic view of the operation conditions of excavating the bulk materials by the excavator according to some embodiments of the present disclosure. The operation scenario shown in FIG. 1 comprises an excavator, a material to be excavated, a lidar sensing device, and a transport vehicle (as a discharge point, not shown in FIG. 1). The excavator is parked in the vicinity of the material to be excavated, so that its excavation operation radius can cover the area of the material. In another scenario, when the total amount or position of the material changes along with the construction of the excavation operation, the excavator may move as the position of the material changes.

In some embodiments of the present disclosure, the lidar may be a lidar sensing device.

In some embodiments of the present disclosure, as shown in FIG. 1, the lidar sensing device is erected outside the material to be excavated, and configured to acquire the point cloud of the material to be excavated so as to acquire a suitable target excavation point; and at the same time, configured to acquire the point cloud of the bucket. When the middle bucket tooth of the bucket is exposed outside the material, it is possible to acquire the point cloud containing the middle bucket tooth of the bucket, and acquire the coordinates PL of the middle bucket tooth of the bucket in the lidar coordinate system by an implicit shape model algorithm.

In some embodiments of the present disclosure, as shown in FIG. 1, angle sensors are mounted on the excavator to acquire the angle information of the excavator, and the coordinates PW of the middle bucket tooth of the bucket in the excavator coordinate system are calculated by a forward kinematics algorithm.

In order to achieve accurate excavation, coordinate calibration has to be performed. In the above-described embodiments of the present disclosure, the coordinates of the middle bucket tooth of the bucket in the lidar coordinate system are calibrated to the excavator coordinate system, and realizes that the coordinates of the middle bucket tooth of the bucket and the coordinates of the target excavation point are uniform in the excavator coordinate system.

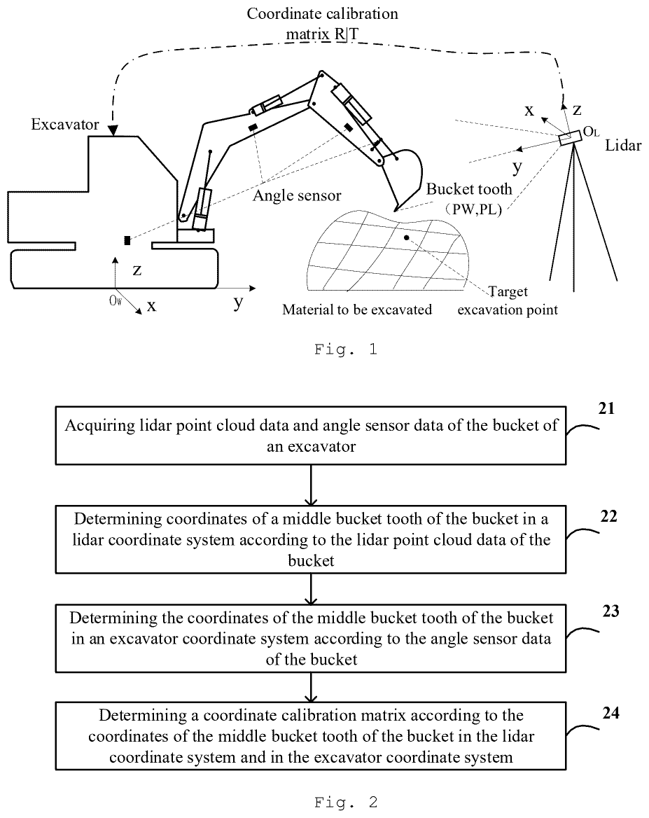

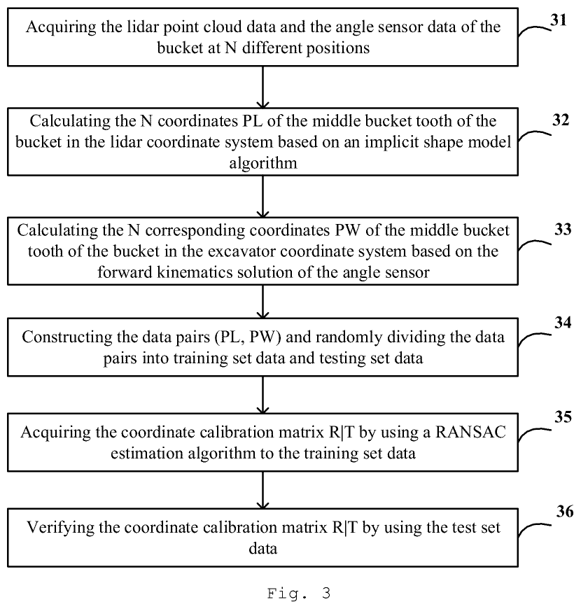

FIG. 2 is a schematic view of the method for calibrating coordinates of a bucket according to some embodiments of the present disclosure. Preferably, the present embodiment may be performed by the device for calibrating coordinates of a bucket of the present disclosure or the calibration system of the present disclosure, or the computer device of the present disclosure or the apparatus for updating coordinate calibration of the present disclosure. The method according to the embodiment of FIG. 2 may comprise at least one of steps 21 to 24.

In the step 21, the lidar point cloud data and the angle sensor data of the bucket are acquired.

In some embodiments of the present disclosure, the step 21 may comprise: acquiring the lidar point cloud data and the angle sensor data of the bucket in a plurality of different positions.

In the step 22, the coordinates of the middle bucket tooth of the bucket in the lidar coordinate system are determined according to the lidar point cloud data of the bucket.

In some embodiments of the present disclosure, the step 22 may comprise: determining the coordinates of the middle bucket tooth of the bucket in the lidar coordinate system according to the lidar point cloud data of the bucket acquired at each of the different positions.

In some embodiments of the present disclosure, the step 22 may comprise: determining the coordinates of the middle bucket tooth of the bucket in the lidar coordinate system according to the lidar point cloud data of the bucket acquired at the each of the different positions by using an implicit shape model algorithm according to the lidar point cloud data of the bucket acquired at the each of the different positions.

In the step 23, the coordinates of the middle bucket tooth of the bucket in the excavator coordinate system are determined according to the angle sensor data of the bucket.

In some embodiments of the present disclosure, the step 23 may comprise: determining the coordinates of the middle bucket tooth of the bucket in the excavator coordinate system according to the angle sensor data of the bucket acquired at the each of the different positions.

In some embodiments of the present disclosure, the step 23 may comprise: calculating a forward kinematics solution of the excavator, to determine the coordinates of the middle bucket tooth of the bucket in the excavator coordinate system according to the angle sensor data of the bucket acquired at the each of the different positions.

In the step 24, the coordinate calibration matrix is determined according to the coordinates of the middle bucket tooth of the bucket in the lidar coordinate system and in the excavator coordinate system, wherein the coordinate calibration matrix is a calibration matrix for calibrating the coordinates of the middle bucket tooth of the bucket in the lidar coordinate system to the excavator coordinate system.

In some embodiments of the present disclosure, the coordinate calibration matrix is a coordinate rotation and translation transformation matrix.

In some embodiments of the present disclosure, the step 24 may comprise: at least one of steps 241 to 243.

In the step 241, a plurality of data pair of the coordinates of the lidar coordinate system and the coordinates of the excavator coordinate system is constructed according to the coordinates of the middle bucket tooth of the bucket in the lidar coordinate system and in the excavator coordinate system, and the plurality of data pairs are divided into training set data and testing set data.

In the step 242, the coordinate calibration matrix is determined according to the training set data.

In the step 243, the coordinate calibration matrix is verified by using the test set data.

In the present disclosure, the coordinates of the bucket are calibrated by using the lidar and the angle sensor of the excavator without adding an external calibration device.

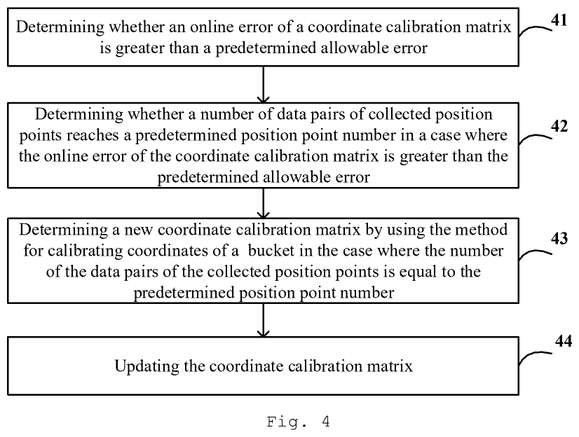

FIG. 3 is a schematic view of the method for calibrating coordinates of a bucket according to other embodiments of the present disclosure. Preferably, the present embodiment may be performed by the device for calibrating coordinates of a bucket of the present disclosure or the calibration system of the present disclosure, or the computer device of the present disclosure or the apparatus for updating coordinate calibration of the present disclosure. The method according to the embodiment of FIG. 3 may comprise: at least one of steps 31 to 36.

In the step 31: the lidar point cloud data and the angle sensor data of the bucket are acquired at N different positions.

In some embodiments of the present disclosure, N different positions mean that the bucket moves to N different spatial positions relative to the excavator coordinate system, and N is set in the procedure, where the value of N is at least greater than 4. The point cloud data of the bucket is acquired based on the lidar coordinate system. The angle sensor data is the data acquired based on the excavator coordinate system.

In some embodiments of the present disclosure, when data is acquired, it is possible to allow that N different spatial positions are greatly different by system detection and control, for example, acquisition is performed according to different rotation intervals, different bucket postures and different boom angles, so as to avoid the phenomenon of data correlation caused by excessively concentrated acquisition positions, which results in the problem that it is impossible to converge during the calculation of the coordinate calibration matrix in the subsequent steps.

In some embodiments of the present disclosure, when data is acquired, it is possible to allow that the bucket is within the range of the visual angle of the lidar at N different spatial positions by system detection and control, so that the lidar can acquire as many point clouds of the bucket as possible, thereby ensuring the configuration accuracy of the subsequently used implicit mode algorithm and improving the similarity.

In some embodiments of the present disclosure, during the process of acquiring data for single calibration, the upper vehicle rotation system, the excavator arm and the bucket may move freely, but the positions of the lower vehicle of the excavator and the lidar should be maintained to be relatively fixed. Otherwise, since the relative positions of the excavator and the lidar change, it is possible to result in that the calibration is inaccurate. Of course, the system may also be configured to perform calibration again upon detecting that the relative positions change.

In the step 32, the N coordinates PL of the middle bucket tooth of the bucket in the lidar coordinate system are calculated by using an implicit shape model algorithm.

In some embodiments of the present disclosure, the step 32 may comprise: calculating the coordinates PL of the middle bucket tooth of the bucket in the lidar coordinate system by using an implicit shape model algorithm according to the bucket lidar point cloud acquired by the bucket at each of the different positions.

In the step 33, the N corresponding coordinates PW of the middle bucket tooth of the bucket in the excavator coordinate system are calculated based on the forward kinematics solution of the angle sensor.

In some embodiments of the present disclosure, the step 33 may comprise: acquiring the coordinates PW of the middle bucket tooth of the bucket in the excavator coordinate system based on the forward kinematics solution according to the angle sensor data of the bucket acquired at each of the different positions.

In the step 34, the data pairs (PL, PW) are constructed and randomly divided into training set data and testing set data.

In some embodiments of the present disclosure, the step 34 may comprise that: the data pairs (PL, PW) are constructed by one-to-one correspondence of the coordinates PL, PW of the middle bucket tooth of the bucket acquired in the above-described step, and the data pairs (PL, PW) are randomly divided into a training set and a testing set wherein the division ratio may be set according to the number of the cumulatively acquired points.

In the step 35, the coordinate calibration matrix R|T is acquired by using a RANSAC (Random Sample Consensus) estimation algorithm to the training set data.

In some embodiments of the present disclosure, the step 35 may comprise: calculating the coordinate calibration matrix R|T by using a RANSAC estimation algorithm to the training set data according to the coordinate calibration model PW=R*PL+T. The RANSAC estimation algorithm used in the present disclosure may avoid the disturbance of the noise data, so that the estimated R|T is accurate and reliable.

In some embodiments of the present disclosure, the object of the coordinate calibration is to find a suitable R|T, to transform the coordinates of the middle bucket tooth of the bucket in the lidar coordinate system to the excavator coordinate system, and calculate the error with the corresponding points, so that it is desirable that all the data pairs have a minimum mean square error, i.e., calculating a minimum value of the formula (1).

$${RE}^{2} = \frac{1}{N} * {\sum }_{i = 1}^{N} ( {( PW - ( R * PL + T ) )}^{2} ) \qquad ( 1 )$$

The inventors have found through studies that: the matrix is directly calculated by using the least square method and DLT (Direct Linear Transformation), but this method sometimes leads to unstable calculation results due to reasons such as the numerical calculation of matrix, inaccurate point correspondence, especially the presence of outliers.

In the above-described steps of the solution according to the present disclosure, the coordinates of the bucket are calculated by using the implicit shape model algorithm according to the bucket point cloud, and at the bottom layer, the actual bucket point cloud is registered with the model point cloud. Since there is a registration similarity between the field acquired bucket point cloud and the model prototype, the higher the similarity, the higher the accuracy of the calculated coordinates of the bucket will be, i.e., the accuracy of the coordinates of the bucket is affected by the model similarity. Therefore, in the present solution, the coordinate calibration matrix R|T is calculated by using the random sample estimation algorithm, RANSAC.

In some embodiments of the present disclosure, the step 242 of the embodiment according to FIG. 2 or the step 35 according to the embodiment of FIG. 3 may comprise: at least one of steps 351 to 359.

In the step 351, the related parameters are initialized, wherein the related parameters comprise parameters such as iteration times, a threshold, a maximum interior point number and an interior point probability.

Steps 352 to 359 are iterative calculations.

In the step 352: a predetermined number of first data pairs are randomly selected, wherein the data pairs are point pairs.

In some embodiments of the present disclosure, the predetermined number may be 4.

In some embodiments of the present disclosure, the step 352 may comprise: randomly selecting 4 pairs of points.

In the step 353, whether the first data pairs are collinear is determined. If so, return to the step 351.

In the step 354, in the case where the first data pairs are not collinear, the coordinate calibration matrix is determined by the direct linear transformation, that is, R|Tᵢ is calculated by using DLT.

In the step 355: the lidar coordinates PLᵢ of the lidar coordinate system in the second data pairs are transformed by using the coordinate calibration matrix R|Tᵢ to acquire the coordinates PWᵢ of the excavator coordinate system, wherein the second data pairs are other data pairs than the first data pairs in the training set data.

In the step 35, the distance deviation between the coordinates of the excavator coordinate system acquired by transformation and the actual coordinates of the excavator coordinate system is calculated.

In the step 357, whether the distance deviation is less than a predetermined distance threshold is determined.

In the step 358, the interior points conforming to the conditions are recorded, and the coordinate calibration matrix R|T is updated according to the iteration times and the determining result of the distance deviation.

In the step 359, the interior point probability is calculated and the iteration times are updated according to the interior point probability.

It is verified that the RANSAC estimation algorithm used in the present disclosure can estimate the model parameters robustly, and estimate the parameters with a high accuracy from the data set containing a large number of outliers.

In the step 36, the coordinate calibration matrix R|T is verified by using the test set data.

In the present disclosure, the coordinate calibration matrix R|T is verified by using the test set data, and if the errors meet the use requirements, the calibration will be completed. During the subsequent operation process of the excavator, PW is transformed to the lidar coordinate system by using R|T, and excavation at the target point and discharge at the discharge point are performed.

The method for calibrating coordinates of a bucket according to the present disclosure will be explained by the following specific embodiments.

### Specific Embodiment 1

After field test, PL and PW of N=8 different positions are acquired.

The coordinates of the middle bucket tooth of the bucket in the lidar coordinate system acquired by point cloud calculation are as follows.

$$\begin{matrix}PL = \{ 3.233 & 2.986 & 3.233 & 3.634 & 3.972 & 2.986 & 2.789 & 2.651 \\ - 0.415 & - 0.738 & - 0.888 & - 0.367 & - 0.662 & - 0.23 & - 0.52 & 0.696 \\ 0.057 & - 0.204 & - 0.38 & - 0.058 & - 0.266 & - 0.322 & - 0.074 & 0.253 \}\end{matrix}$$

The coordinates of the middle bucket tooth of the bucket in the excavator coordinate system acquired by the forward kinematics solution of the angle sensor, are as follows.

$$\begin{matrix}PW = \{ 4.27 & 4.2 & 3.94 & 4.04 & 3.6 & 4.6 & 4.53 & 4.43 // x \\ 0.74 & 1.13 & 1.07 & 0.5 & 0.45 & 0.8 & 1.12 & 1.33 // y \\ 0.36 & 0.11 & - 0.07 & 0.24 & 0.01 & 0.01 & 0.24 & 0.58 \} // z\end{matrix}$$

The data set is divided at a ratio of 6:4 to acquire the training set, as follows.

$$\begin{matrix}PL\_train = \{ 3.233 & 2.986 & 3.233 & 3.634 & 3.972 \\ - 0.415 & - 0.738 & - 0.888 & - 0.367 & - 0.662 \\ 0.057 & - 0.204 & - 0.38 & - 0.058 & - 0.266 \}\end{matrix}$$

$$\begin{matrix}PW\_train = \{ 4.27 & 4.2 & 3.94 & 4.04 & 3.603 & \\ 0.74 & 1.13 & 1.07 & 0.5 & 0.45 & 0.8 \\ 0.36 & 0.11 & - 0.07 & 0.24 & 0.01 \} & \end{matrix}$$

The test set is as follows.

$$\begin{matrix}PL\_test = \{ 2.986 & 2.789 & 2.651 \\ - 0.23 & - 0.52 & - 0.696 \\ - 0.322 & - 0.074 & 0.253 \}\end{matrix}$$

$$\begin{matrix}PW\_test = \{ 4.6 & 4.53 & 4.43 \\ 0.8 & 1.12 & 1.33 \\ 0.01 & 0.24 & 0.58 \}\end{matrix}$$

The coordinate calibration matrix R|T is acquired by using the RANSAC estimation algorithm, wherein:

$$\begin{matrix}R = \{ - 0.7098 & 0.7033 & - 0.0408 \\ - 0.7028 & - 0.7109 & - 0.0273 \\ - 0.0482 & 0.0093 & 0.9988 \}\end{matrix}$$

$$\begin{matrix}T = \{ 6.8549 \\ 2.7214 \\ 0.4704 \}\end{matrix}$$

Verification is performed by the test set, res=PW test−(PL_test*R+T), to acquire the deviation matrix, so that it is possible to calculate the error magnitude res of each point in the x, y and z directions, i.e., and the mean square error RE2 as follows:

$$\begin{matrix}res = \{ - 0.0131 & - 0.0173 & 0.0435 \\ - 0.0048 & 0.0131 & 0.0162 \\ - 0.0073 & 0.0172 & 0.0088 \}\end{matrix}$$

$$RE 2 = 0.0189$$

The maximum error is 4.35 cm, and the mean square error is 1.89 cm. The needs of excavating the bulk material are satisfied.

FIG. 4 is a schematic view of the method for updating coordinate calibration according to some embodiments of the present disclosure. Preferably, the present embodiment may be performed by the calibration system of the present disclosure or the computer device of the present disclosure or the apparatus for updating coordinate calibration of the present disclosure. The method according to the embodiment of FIG. 4 may comprise: at least one of steps 41 to 44.

In the step 41, whether the online error of the coordinate calibration matrix is greater than the predetermined allowable error is determined.

In the step 42, whether the number of the data pairs of the acquired position points reaches the predetermined position point number is determined in the case where the online error of the coordinate calibration matrix is greater than the predetermined allowable error.

In the step 43, in the case where the number of the data pairs of the acquired position points is equal to the number of predetermined position point number, a new coordinate calibration matrix is determined by using for calibrating coordinates of a bucket according to any of the above-described embodiments (for example, the embodiment of FIG. 2 or FIG. 3).

In the step 44, the coordinate calibration matrix is updated.

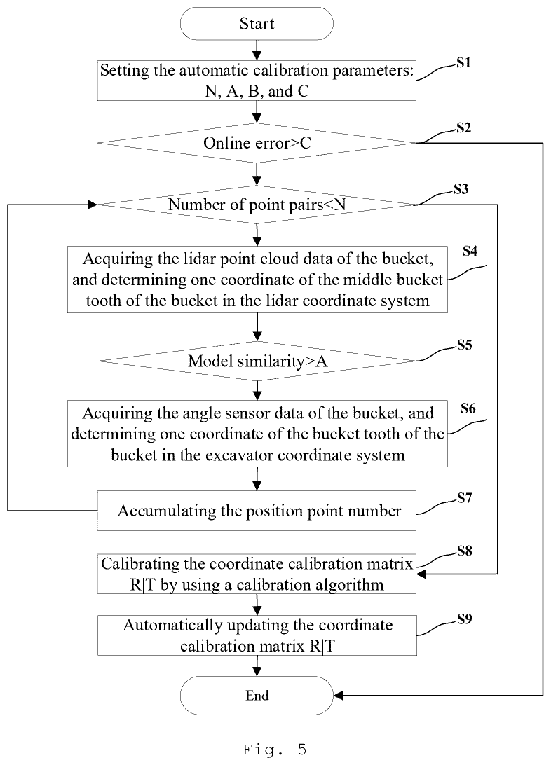

FIG. 5 is a schematic view of the method for updating coordinate calibration according to other embodiments of the present disclosure. Preferably, the present embodiment may be performed by the calibration system of the present disclosure or the computer device of the present disclosure or the apparatus for updating coordinate calibration of the present disclosure. The method according to the embodiment of FIG. 5 may comprise: at least one step from step S1 to step S9.

In the step S1, the automatic calibration parameters, such as: the position point number N, the predetermined similarity A, the division ratio B, and the predetermined allowable error C, are set.

In some embodiments of the present disclosure, the position point number N (the number N of the position points) means that the bucket moves to N different spatial positions relative to the excavator coordinate system, and N is set in the procedure, wherein the value of N is at least greater than 4.

In some embodiments of the present disclosure, the predetermined similarity A refers to the degree of registration similarity between the bucket point cloud of the implicit shape model algorithm and the bucket point cloud of the model.

In some embodiments of the present disclosure, the division ratio B refers to the division ratio of the training set (PL, PW) to the test set (PL, PW).

In some embodiments of the present disclosure, the predetermined allowable error C refers to the error that meets the use requirements. The automatic calibration parameters may be set by configuration files.

In the step S2, whether the online error is greater than the preset allowable error C is determined.

In some embodiments of the present disclosure, the online error is calculated by the formula PW−(R*PL+T). In the case where the system is used for the first time, or in the case where the relative positions between the excavator and the lidar change, the online error will be greater than the set allowable error. At this time, it is possible to enter the automatic calibration procedure, and enter the step S3. After the calibration is successful, it is possible to directly exit from the calibration procedure.

In the step S3, whether the number of the acquired point pairs (the number of the data pairs of the position points) is less than the predetermined position point number N is determined. If the number of the data pairs of the acquired position points is less than the predetermined position point number N, the step S4 is preformed; and if the number of the data pairs of the acquired position points is equal to the predetermined position point number N, the step S8 is performed.

In the step S4, the lidar point cloud data of the bucket is acquired, and one coordinate of the middle bucket tooth of the bucket in the lidar coordinate system is determined.

In some embodiments of the present disclosure, the step S4 may comprise: acquiring the lidar point cloud data of the bucket, and acquiring one coordinate PL1 of the middle tooth of the bucket by using an implicit shape model algorithm.

In some embodiments of the present disclosure, in the case where data is acquired, according to the different positions of the bucket relative to the excavator, the bucket is acquired within a proper range of the visual angle of the lidar, so as to acquire a reasonable bucket point cloud, thereby increasing the success rate of the model registration and improving the model similarity.

In the step S5, whether the model similarity is greater than the predetermined similarity A is determined.

In some embodiments of the present disclosure, in the case where the model similarity is greater than the predetermined similarity A, it is accepted that one coordinate PL1 of the middle bucket tooth of the bucket is acquired by using an implicit shape model algorithm, to enter the step S6 so as to acquire the coordinates PW1 of the middle bucket tooth of the bucket in the excavator coordinate system.

In the step S6, the angle sensor data of the bucket is acquired, and one coordinate of the bucket tooth of the bucket in the excavator coordinate system is determined.

In some embodiments of the present disclosure, the step S6 may comprise: acquiring the angle sensor data of the bucket, and calculating one coordinate PW1 of the middle bucket tooth of the bucket based on the kinematics solution of the angle sensor.

In the step S7, the position point number is accumulated.

In some embodiments of the present disclosure, the step S7 may comprise: counting the number of point pairs (PL1, PW1) successfully paired; and proceeding to the step S8 in the case where the data is equal to N.

In the step S8, the coordinate calibration matrix R|T is calibrated by using a calibration algorithm.

In some embodiments of the present disclosure, the step S8 may comprise: determining a new coordinate calibration matrix by using the method for calibrating coordinates of a bucket according to any of the above-described embodiments (for example, the embodiment of FIG. 2 or FIG. 3) in the case where the number of the data pairs of the acquired position points is equal to the predetermined position point number.

In the step S9, the coordinate calibration matrix R|T is automatically updated.

After successful calibration in the present disclosure, the R|T may be automatically updated or the operator may be reminded to decide whether to use the R|T.

For the problems that the calibration has a low accuracy and is time-consuming and labor-intensive, a particular scenario or a special calibration device is required, online verification is absent and it is impossible to perform online calibration, present in the calibration methods such as a direct measurement method, a manual point selection method and a scenario characterization method, the present disclosure provides a coordinate calibration method and an automatically updating method based on a lidar and an angle sensor.

Firstly, in the present disclosure, the calibration may be completed without adding any calibration device on the related system.

Secondly, in the present disclosure, filtering is performed by using the model similarity, thereby improving the calibration accuracy by using the RANSAC estimation algorithm.

Thirdly, in the present disclosure, the data set is randomly divided and the online verification function is provided.

Fourthly, in the present disclosure, it is possible to perform automatic calibration and updating in the case where the relative positions of the excavator and the lidar change and in the case where the coordinate calibration matrix generates a drift error.

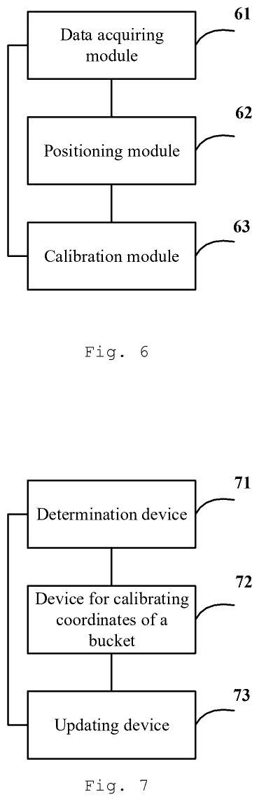

FIG. 6 is a schematic view of some embodiments of the device for calibrating coordinates of a bucket of the present disclosure. As shown in FIG. 6, the device for calibrating coordinates of a bucket of the present disclosure may comprise: a data acquiring module 61, a positioning module 62 and a calibration module 63.

The data acquiring module 61 is configured to acquire lidar point cloud data and angle sensor data of the bucket of an excavator.

In some embodiments of the present disclosure, the data acquiring module 61 is configured to acquire the lidar point cloud data and the angle sensor data of the bucket in a plurality of different positions.

The positioning module 62 is configured to determine coordinates of a middle bucket tooth of the bucket in a lidar coordinate system according to the lidar point cloud data of the bucket; and determine the coordinates of the middle bucket tooth of the bucket in an excavator coordinate system according to the angle sensor data of the bucket.

In some embodiments of the present disclosure, the positioning module 62 is configured to determine the coordinates of the middle bucket tooth of the bucket in the lidar coordinate system according to the lidar point cloud data of the bucket acquired at each of the different positions in the case where the coordinates of the middle bucket tooth of the bucket in the lidar coordinate system are determined according to the lidar point cloud data of the bucket.

In some embodiments of the present disclosure, the positioning module 62 is configured to determine the coordinates of the middle bucket tooth of the bucket in the lidar coordinate system by using an implicit shape model algorithm according to the lidar point cloud data of the bucket acquired at the each of the different positions, in the case where the coordinates of the middle bucket tooth of the bucket in the lidar coordinate system are determined according to the lidar point cloud data of the bucket.

In some embodiments of the present disclosure, the positioning module 62 is configured to the coordinates of the middle bucket tooth of the bucket in the excavator coordinate system according to the angle sensor data of the bucket acquired at the each of the different positions in the case where the coordinates of the middle bucket tooth of the bucket in the excavator coordinate system are determined according to the angle sensor data of the bucket.

In some embodiments of the present disclosure, the positioning module 62 is configured to a forward kinematics solution of the excavator, to determine the coordinates of the middle bucket tooth of the bucket in the excavator coordinate system according to the angle sensor data of the bucket acquired at the each of the different positions, in the case where the coordinates of the middle bucket tooth of the bucket in the excavator coordinate system are determined according to the angle sensor data of the bucket.

The calibration module 63 is configured to determine a coordinate calibration matrix according to the coordinates of the middle bucket tooth of the bucket in the lidar coordinate system and in the excavator coordinate system, wherein the coordinate calibration matrix is a calibration matrix for calibrating the coordinates of the middle bucket tooth of the bucket in the lidar coordinate system to the excavator coordinate system.

In some embodiments of the present disclosure, the coordinate calibration matrix is a coordinate rotation and translation transformation matrix.

In some embodiments of the present disclosure, the calibration module 63 is configured to construct a plurality of data pairs of the coordinates of the lidar coordinate system and the coordinates of the excavator coordinate system according to the coordinates of the middle bucket tooth of the bucket in the lidar coordinate system and in the excavator coordinate system, and dividing the plurality of data pairs into training set data and testing set data; determine the coordinate calibration matrix according to the training set data; and verify the coordinate calibration matrix by using the test set data.

In some embodiments of the present disclosure, the calibration module 63 is configured to initialize the related parameters in the case where the coordinate calibration matrix is determined according to the training set data, wherein the related parameters comprise the iteration times; select a predetermined number of first data pairs randomly, determine whether the first data pairs are collinear, and determine the coordinate calibration matrix by direct linear transformation in the case where the first data pairs are not collinear, in the case where the coordinate calibration matrix is determined according to the training set data.

In some embodiments of the present disclosure, the calibration module 63 is further configured to transform the coordinates of the lidar coordinate system in second data pairs to acquire the coordinates of the excavator coordinate system by using the coordinate calibration matrix, wherein the second data pairs are data pairs other than the first data pairs in the training set data, calculate a distance deviation between the transformed coordinates of the excavator coordinate system and the actual coordinates of the excavator coordinate system, determine whether the distance deviation is smaller than a predetermined distance threshold; record the interior points conforming to conditions and updating the coordinate calibration matrix according to the iteration times and the determining result of the distance deviation, and calculate the interior point probability and update the iteration times according to the interior point probability, in the case where the coordinate calibration matrix is determined according to the training set data.

In some embodiments of the present disclosure, the device for calibrating coordinates of a bucket is configured to perform the operations of implementing the method for calibrating coordinates of a bucket according to any of the above-described embodiments (for example, the embodiment of FIG. 2 or FIG. 3).

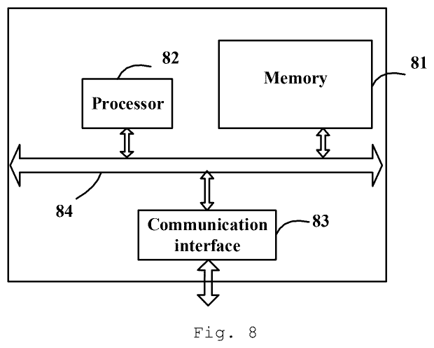

FIG. 7 is a schematic view of some embodiments of the apparatus for updating coordinate calibration of the present disclosure. As shown in FIG. 7, the apparatus for updating coordinate calibration of the present disclosure may comprise: a determination device 71, a device 72 for calibrating coordinates of a bucket and an updating device 73, wherein:

The determination device 71 is configured to determine whether an online error of a coordinate calibration matrix is greater than a predetermined allowable error; and determine whether a number of data pairs of acquired position points reaches a predetermined position point number in a case where the online error of the coordinate calibration matrix is greater than the predetermined allowable error.

The device 72 for calibrating coordinates of a bucket is configured to determine a new coordinate calibration matrix by using the method for calibrating coordinates of a bucket in the case where the number of the data pairs of the acquired position points is equal to the predetermined position point number.

The updating device 73 is configured to update the coordinate calibration matrix.

In some embodiments of the present disclosure, the device 72 for calibrating coordinates of a bucket is the device for calibrating coordinates of a bucket according to any of the above-described embodiments (for example, the embodiment of FIG. 6).

In some embodiments of the present disclosure, the determination device 71 is further configured to acquire the lidar point cloud data of the bucket and determining one coordinate of the middle bucket tooth of the bucket in the lidar coordinate system in the case where the number of the data pairs of the acquired position points is less than the predetermined position point number; acquire the angle sensor data of the bucket and determining one coordinate of the middle bucket tooth of the bucket in the excavator coordinate system; and accumulate the number of the data pairs of the position points, and then performing the determining whether the number of the data pairs of the acquired position points reaches the predetermined position point number again.

In some embodiments of the present disclosure, the determination device 71 is configured to acquire one coordinate of the middle bucket tooth of the bucket in the lidar coordinate system by using an implicit shape model algorithm, in the case where one coordinate of the middle bucket tooth of the bucket in the lidar coordinate system is determined; determine whether the model similarity is greater than the predetermined similarity; and use the acquired one coordinate of the middle bucket tooth of the bucket in the lidar coordinate system in the case where the model similarity is greater than the preset similarity.

In some embodiments of the present disclosure, the determination device 71 is configured to calculate a forward kinematics solution of the excavator based on the angle sensor data, and determine the one coordinate of the middle bucket tooth of the bucket in the excavator coordinate system, in the case where one coordinate of the middle bucket tooth of the bucket in the excavator coordinate system is determined.

In some embodiments of the present disclosure, the apparatus for updating coordinate calibration is configured to perform the operations of implementing the method for updating coordinate calibration according to any of the above-described embodiments (for example, the embodiment of FIG. 4 or FIG. 5).

The above-described embodiments of the present disclosure provide a coordinate calibration device and an automatic updating device based on a lidar and an angle sensor, wherein the coordinates of the bucket are calibrated and automatically updated by using the lidar and the angle sensor of the excavator without adding an external calibration device, which realizes that the coordinates of the bucket are uniform with the coordinates of the target excavation point in the excavator coordinate system.

FIG. 8 is a structural view of some embodiments of the computer device of the present disclosure. As shown in FIG. 8, the computer device comprises a memory 81 and a processor 82.

The memory 81 is configured to store instructions, the processor 82 is coupled to the memory 81, and the processor 82 is configured to perform the method according to the above-described embodiments (for example, any of the embodiments of FIGS. 2 to 5) based on the instructions stored in the memory.

As shown in FIG. 8, the computer device also comprises a communication interface 83 for information interaction with other devices. At the same time, the computer device also comprises a bus 84, wherein the processor 82, the communication interface 83 and the memory 81 complete communication with each other via the bus.

The memory 81 may contain a high-speed RAM memory or a non-volatile memory, for example at least one disk memory. The memory 81 may also be a memory array. The memory 81 may also be divided into blocks which may be combined into virtual volumes according to certain rules.

In addition, the processor 82 may be a central processing unit CPU, or an application specific integrated circuit ASIC, or one or more integrated circuits configured to implement the embodiments of the present disclosure.

According to another aspect of the present disclosure, as shown in FIG. 1, a calibration system is provided. The system comprises a lidar and an angle sensor, and further comprises at least one of a computer device, an apparatus for updating coordinate calibration and a device for calibrating coordinates of a bucket, wherein the computer device is the computer device according to any of the above-described embodiments (for example, the embodiment of FIG. 8), the apparatus for updating coordinate calibration is the apparatus for updating coordinate calibration according to any of the above-described embodiments (for example, the embodiment of FIG. 7), and the device for calibrating coordinates of a bucket is the device for calibrating coordinates of a bucket according to any of the above-described embodiments (for example, the embodiment of FIG. 6).

According to another aspect of the present disclosure, as shown in FIG. 1, an excavator is provided. The excavator comprises a lidar, and further comprises at least one of a computer device, an apparatus for updating coordinate calibration and a device for calibrating coordinates of a bucket, wherein the computer device is the computer device according to any of the above-described embodiments (for example, the embodiment of FIG. 8), the apparatus for updating coordinate calibration is the apparatus for updating coordinate calibration according to any of the above-described embodiments (for example, the embodiment of FIG. 7), and the device for calibrating coordinates of a bucket is the device for calibrating coordinates of a bucket according to any of the above-described embodiments (for example, the embodiment of FIG. 6).

The above-described embodiments of the present disclosure provide a coordinate calibration method and an automatic updating method based on a lidar and an angle sensor, wherein the coordinates of the bucket are calibrated and automatically updated by using the lidar and the angle sensor of the excavator without adding an external calibration device, which realizes that the coordinates of the bucket are uniform with the coordinates of the target excavation point in the excavator coordinate system.

According to another aspect of the present disclosure, a computer-readable storage medium is provided, wherein the computer-readable storage medium has computer instructions stored thereon that, when executed by a processor, implement the method for calibrating coordinates of a bucket according to any of the above-described embodiments (for example, the embodiment of FIG. 2 or FIG. 3) and/or implement the operations of the method for updating coordinate calibration according to any of the above-described embodiments (for example, the embodiment of FIG. 4 or FIG. 5).

In some embodiments of the present disclosure, the computer-readable storage medium may be a non-transitory computer-readable storage medium.

Those skilled in the art will appreciate that the embodiments of the present disclosure may be provided as a method, device, or computer program product. Accordingly, the present disclosure may take the form of an entirely hardware embodiment, an entirely software embodiment, or a combination of software and hardware aspects. Moreover, the present disclosure may take the form of a computer program product embodied in one or more computer-usable non-transitory storage media (including but not limited to disk memory, CD-ROM, optical memory, and the like) containing computer usable program codes therein.

The present disclosure is described with reference to the flow charts and/or block views of the methods, devices (systems), and computer program products according to the embodiments of the present disclosure. It will be understood that each step and/or block of the flow charts and/or block views as well as a combination of steps and/or blocks of the flow charts and/or block views may be implemented by a computer program instruction. These computer program instructions may be provided to a processor of a general purpose computer, special purpose computer, an embedded processing machine, or other programmable data processing devices to produce a machine, such that the instructions executed by a processor of a computer or other programmable data processing devices produce a device for realizing a function designated in one or more steps of a flow chart and/or one or more blocks in a block view.

These computer program instructions may also be stored in a computer-readable memory that may guide a computer or other programmable data processing device to operate in a particular manner, such that the instructions stored in the computer-readable memory produce a manufacture including an instruction device. The instruction device realizes a function designated in one or more steps in a flow chart or one or more blocks in a block view.

These computer program instructions may also be loaded onto a computer or other programmable data processing devices, such that a series of operational steps are performed on a computer or other programmable device to produce a computer-implemented processing, such that the instructions executed on a computer or other programmable devices provide steps for realizing a function designated in one or more steps of the flow chart and/or one or more blocks in the block view.

The computer device, the device for calibrating coordinates of a bucket, the data acquiring module, the positioning module, the calibrating module, the apparatus for updating coordinate calibration, the determination device and the updating device described above may be implemented as a general purpose processor, a programmable logic controller (PLC), a digital signal processor (DSP), an application specific integrated circuit (ASIC), a field-programmable gate array (FPGA) or other programmable logic devices, discrete gates or transistor logic devices, discrete hardware assemblies or any proper combination thereof, which is configured to perform the functions described in the present application.

Hitherto, the present disclosure has been described in detail. Some details well known in the art are not described in order to avoid obscuring the concept of the present disclosure. According to the above description, those skilled in the art would fully understand how to implement the technical solutions disclosed here.

Those of ordinary skill in the art may understand that all or some of the steps in the above-described embodiments may be accomplished by hardware, or by programs to instruct relevant hardware. The programs may be stored in a non-transitory computer-readable storage medium. The storage medium as mentioned above may be read-only memory, magnetic disk or optical disk, and the like.

Descriptions of the present disclosure, which are made for purpose of exemplification and description, are not absent with omissions or limit the present disclosure to the forms as disclosed. Many modifications and variations are apparent for those skilled in the art. The embodiments are selected and described in order to better explain the principles and actual application of the present disclosure, and enable those skilled in the art to understand the present disclosure so as to design various embodiments adapted to particular purposes and including various modifications.

1. A method for calibrating coordinates of a bucket, comprising:
acquiring lidar point cloud data and angle sensor data of the bucket of an excavator;
determining coordinates of a middle bucket tooth of the bucket in a lidar coordinate system according to the lidar point cloud data of the bucket;
determining the coordinates of the middle bucket tooth of the bucket in an excavator coordinate system according to the angle sensor data of the bucket; and
determining a coordinate calibration matrix according to the coordinates of the middle bucket tooth of the bucket in the lidar coordinate system and in the excavator coordinate system, wherein the coordinate calibration matrix is a calibration matrix for calibrating the coordinates of the middle bucket tooth of the bucket in the lidar coordinate system to the excavator coordinate system.

2. The method according to claim 1, wherein:
the acquiring the lidar point cloud data and the angle sensor data of the bucket of the excavator comprises: acquiring the lidar point cloud data and the angle sensor data of the bucket in a plurality of different positions;
the determining the coordinates of the middle bucket tooth of the bucket in the lidar coordinate system according to the lidar point cloud data of the bucket comprises: determining the coordinates of the middle bucket tooth of the bucket in the lidar coordinate system according to the lidar point cloud data of the bucket acquired at each of the different positions; and
the determining the coordinates of the middle bucket tooth of the bucket in the excavator coordinate system according to the angle sensor data of the bucket comprises: determining the coordinates of the middle bucket tooth of the bucket in the excavator coordinate system according to the angle sensor data of the bucket acquired at the each of the different positions.

3. The method according to claim 2, wherein:
the determining the coordinates of the middle bucket tooth of the bucket in the lidar coordinate system according to the lidar point cloud data of the bucket acquired at the each of the different positions comprises: determining the coordinates of the middle bucket tooth of the bucket in the lidar coordinate system by using an implicit shape model algorithm according to the lidar point cloud data of the bucket acquired at the each of the different positions; and
the determining the coordinates of the middle bucket tooth of the bucket in the excavator coordinate system according to the angle sensor data of the bucket acquired at the each of the different positions comprises: calculating a forward kinematics solution of the excavator, to determine the coordinates of the middle bucket tooth of the bucket in the excavator coordinate system according to the angle sensor data of the bucket acquired at the each of the different positions.

4. The method according to claim 1, wherein the determining the coordinate calibration matrix according to the coordinates of the middle bucket tooth of the bucket in the lidar coordinate system and in the excavator coordinate system comprises:
constructing a plurality of data pairs of the coordinates of the lidar coordinate system and the coordinates of the excavator coordinate system according to the coordinates of the middle bucket tooth of the bucket in the lidar coordinate system and in the excavator coordinate system, and dividing the plurality of data pairs into training set data and testing set data;
determining the coordinate calibration matrix according to the training set data; and
verifying the coordinate calibration matrix by using the test set data.

5. The method according to claim 1, wherein the coordinate calibration matrix is a coordinate rotation and translation transformation matrix.

6. The method according to claim 4, wherein the determining the coordinate calibration matrix according to the training set data comprises:
initializing related parameters, wherein the related parameters comprise iteration times;
selecting a predetermined number of first data pairs randomly;
determining whether the first data pairs are collinear; and
determining the coordinate calibration matrix by a direct linear transformation in a case where the first data pairs are not collinear.

7. The method according to claim 6, wherein the determining the coordinate calibration matrix according to the training set data, further comprises:
transforming the coordinates of the lidar coordinate system in second data pairs to acquire the coordinates of the excavator coordinate system by using the coordinate calibration matrix, wherein the second data pairs are data pairs other than the first data pairs in the training set data;
calculating a distance deviation between the transformed coordinates of the excavator coordinate system and the actual coordinates of the excavator coordinate system;
determining whether the distance deviation is smaller than a predetermined distance threshold;
recording interior points conforming to conditions and updating the coordinate calibration matrix according to the iteration times and the determining result of the distance deviation; and
calculating an interior point probability and updating the iteration times according to the interior point probability.

8. A method for updating coordinate calibration, comprising:
determining whether an online error of a coordinate calibration matrix is greater than a predetermined allowable error;
determining whether a number of data pairs of acquired position points reaches a predetermined position point number in a case where the online error of the coordinate calibration matrix is greater than the predetermined allowable error;
determining a new coordinate calibration matrix by using the method according to claim 1 in a case where the number of the data pairs of the acquired position points is equal to the predetermined position point number; and
updating the coordinate calibration matrix.

9. The method according to claim 8, further comprising:
acquiring the lidar point cloud data of the bucket and determining one coordinate of the middle bucket tooth of the bucket in the lidar coordinate system in a case where the number of the data pairs of the acquired position points is less than the predetermined position point number;
acquiring the angle sensor data of the bucket and determining one coordinate of the middle bucket tooth of the bucket in the excavator coordinate system; and
accumulating the number of the data pairs of the position points, and then performing the determining whether the number of the data pairs of the acquired position points reaches the predetermined position point number again.

10. The method according to claim 9, wherein:
the determining one coordinate of the middle bucket tooth of the bucket in the lidar coordinate system comprises: acquiring one coordinate of the middle bucket tooth of the bucket in the lidar coordinate system by using an implicit shape model algorithm; determining whether a model similarity is greater than a predetermined similarity; and using the acquired one coordinate of the middle bucket tooth of the bucket in the lidar coordinate system in a case where the model similarity is greater than the preset similarity; and
the determining one coordinate of the middle bucket tooth of the bucket in the excavator coordinate system comprises: calculating a forward kinematics solution of the excavator based on the angle sensor data and determining the one coordinate of the middle bucket tooth of the bucket in the excavator coordinate system.

11.-15. (canceled)

16. A computer device comprising:
a memory for storing instructions;
a processor configured to execute a method for performing the instructions comprising:
acquiring lidar point cloud data and angle sensor data of the bucket of an excavator;
determining coordinates of a middle bucket tooth of the bucket in a lidar coordinate system according to the lidar point cloud data of the bucket;
determining the coordinates of the middle bucket tooth of the bucket in an excavator coordinate system according to the angle sensor data of the bucket; and
determining a coordinate calibration matrix according to the coordinates of the middle bucket tooth of the bucket in the lidar coordinate system and in the excavator coordinate system, wherein the coordinate calibration matrix is a calibration matrix for calibrating the coordinates of the middle bucket tooth of the bucket in the lidar coordinate system to the excavator coordinate system.

17. A calibration system, comprising a lidar, an angle sensor and the computer device according to claim 16.

18. An excavator, comprising a lidar, and the computer device is the computer device according to claim 16.

19. A computer-readable storage medium, wherein the computer-readable storage medium has computer instructions stored thereon that when executed by a processor, perform a method comprising:
acquiring lidar point cloud data and angle sensor data of the bucket of an excavator;
determining coordinates of a middle bucket tooth of the bucket in a lidar coordinate system according to the lidar point cloud data of the bucket;
determining the coordinates of the middle bucket tooth of the bucket in an excavator coordinate system according to the angle sensor data of the bucket; and
determining a coordinate calibration matrix according to the coordinates of the middle bucket tooth of the bucket in the lidar coordinate system and in the excavator coordinate system, wherein the coordinate calibration matrix is a calibration matrix for calibrating the coordinates of the middle bucket tooth of the bucket in the lidar coordinate system to the excavator coordinate system.

20. A non-transitory computer-readable storage medium, wherein the computer-readable storage medium has computer instructions stored thereon that when executed by a processor, perform a method comprising:
determining whether an online error of a coordinate calibration matrix is greater than a predetermined allowable error;
determining whether a number of data pairs of acquired position points reaches a predetermined position point number in a case where the online error of the coordinate calibration matrix is greater than the predetermined allowable error;
determining a new coordinate calibration matrix by using the method according to claim 1 in a case where the number of the data pairs of the acquired position points is equal to the predetermined position point number; and
updating the coordinate calibration matrix.

21. A computer device comprising:
a memory for storing instructions;
a processor configured to execute a method for performing the instructions comprising:
determining whether an online error of a coordinate calibration matrix is greater than a predetermined allowable error;
determining whether a number of data pairs of acquired position points reaches a predetermined position point number in a case where the online error of the coordinate calibration matrix is greater than the predetermined allowable error;
determining a new coordinate calibration matrix by using the method according to claim 1 in a case where the number of the data pairs of the acquired position points is equal to the predetermined position point number; and
updating the coordinate calibration matrix.

22. The computer device according to claim 16, wherein:
the acquiring the lidar point cloud data and the angle sensor data of the bucket of the excavator comprises: acquiring the lidar point cloud data and the angle sensor data of the bucket in a plurality of different positions;
the determining the coordinates of the middle bucket tooth of the bucket in the lidar coordinate system according to the lidar point cloud data of the bucket comprises: determining the coordinates of the middle bucket tooth of the bucket in the lidar coordinate system according to the lidar point cloud data of the bucket acquired at each of the different positions; and
the determining the coordinates of the middle bucket tooth of the bucket in the excavator coordinate system according to the angle sensor data of the bucket comprises: determining the coordinates of the middle bucket tooth of the bucket in the excavator coordinate system according to the angle sensor data of the bucket acquired at the each of the different positions.

23. The computer device according to claim 22, wherein:
the determining the coordinates of the middle bucket tooth of the bucket in the lidar coordinate system according to the lidar point cloud data of the bucket acquired at the each of the different positions comprises: determining the coordinates of the middle bucket tooth of the bucket in the lidar coordinate system by using an implicit shape model algorithm according to the lidar point cloud data of the bucket acquired at the each of the different positions; and
the determining the coordinates of the middle bucket tooth of the bucket in the excavator coordinate system according to the angle sensor data of the bucket acquired at the each of the different positions comprises: calculating a forward kinematics solution of the excavator, to determine the coordinates of the middle bucket tooth of the bucket in the excavator coordinate system according to the angle sensor data of the bucket acquired at the each of the different positions.

24. The computer device according to claim 16, wherein the determining the coordinate calibration matrix according to the coordinates of the middle bucket tooth of the bucket in the lidar coordinate system and in the excavator coordinate system comprises:
constructing a plurality of data pairs of the coordinates of the lidar coordinate system and the coordinates of the excavator coordinate system according to the coordinates of the middle bucket tooth of the bucket in the lidar coordinate system and in the excavator coordinate system, and dividing the plurality of data pairs into training set data and testing set data;
determining the coordinate calibration matrix according to the training set data; and
verifying the coordinate calibration matrix by using the test set data.

25. The computer device according to claim 24, wherein the determining the coordinate calibration matrix according to the training set data comprises:
initializing related parameters, wherein the related parameters comprise iteration times;
selecting a predetermined number of first data pairs randomly;
determining whether the first data pairs are collinear; and
determining the coordinate calibration matrix by a direct linear transformation in a case where the first data pairs are not collinear.
